(19) United States
(12) Patent Application Publication
(10) Pub. No.: US 2012/0235587 A1
(43) Pub. Date: Sep. 20, 2012

(54) CIRCUIT WITH PASSIVE COMPONENTS FOR HIGH-SPEED DRIVE OF AN OPTOELECTRONIC DEVICE

(75) Inventors: Phi Hoa Binh, Hanoi (VN); Xavier Marie, Pechabou (FR); Pierre Renucci, Castanet Tolosan (FR); Viet Giang Truong, Toulouse (FR)

(73) Assignee: Institut National Des Sciences Appliquees De Toulouse, Toulouse Cedex 4 (FR)

(21) Appl. No.: 13/513,008

(22) PCT Filed: Nov. 24, 2010
(86) PCT No.: PCT/FR2010/052514

§ 371 Date: May 31, 2012

(30) Foreign Application Priority Data
Dec. 1, 2009 (FR) 09.05792

(51) Int. Cl. H05B 37/02

(52) U.S. Cl. 315/201

(57) ABSTRACT

A circuit for the ultra-quick control of an optoelectronic device, includes a generator of voltage pulses having a pulse duration of less than 400 ps, and a circuit (17) for shaping control pulses including: an output suitable for being connected in series to a line terminal (13) of the optoelectronic device, and an input connected to the voltage-pulse generator and receiving the voltage pulses formed by the latter, between a terminal of the input and a terminal of the output, mounted in parallel in relation to one another: a first branch (20) made up of a passive rectifier circuit (22a, 22b) having non-zero threshold voltage and, in series in the first branch in forward direction relative to the line terminal (13) of the optoelectronic device, a second capacitive branch (21).

The invention relates to a circuit for high-speed drive of an optoelectronic device, this latter including at least one optoelectronic diode (LED(s), semiconductor laser diode(s)).

High-speed drive of such optoelectronic diodes is important in the field of high-throughput optical telecommunications (for example, within the scope of the FTTH Internet project using optical fibres, the FSO (free-space optical communication) applications, in which beams of light are emitted from the ceiling of a room in order to replace WIFI connections, or the applications of optical connections between components on electronic cards and/or between electronic cards and/or as buses in computers). Until now, the light-sources used in such applications have been semiconductor laser diodes requiring expensive devices for wavelength control and for temperature stabilisation. Commercial light-emitting diodes (LEDs) are more economical than laser diodes but exhibit a limited modulation frequency, typically below or of the order of 150 MHz, insufficient to attain the throughputs currently being sought, greater than several hundred megabits per second, typically of the order of several gigabits per second. Indeed, for optical telecommunications with such throughputs it is necessary to be able to drive the light-sources at frequencies greater than 1 GHz or even of the order of several tens of gigahertz.

Moreover, high-speed drive of optoelectronic diodes is also necessary in pieces of scientific equipment (notably for the optical detection of molecules, techniques of fluorescence spectroscopy etc.) that require light-sources producing short pulses (a few hundred picoseconds), even if the repetition frequency may be less than 100 MHz.

The known drive circuits for optoelectronic diodes are complex systems comprising a circuit for shaping of driving pulses, including active components such as bipolar transistors or circuits of RC type which are relatively inefficient and which result in losses (cf. for example, EP 0 470 780, U.S. Pat. No. 5,329,210; integrated circuit, reference MC2042-4 (http://www.mindspeed.com); E. F. Schubert, N. E. J. Hunt, R. J. Malik, M. Micovic and D. L. Miller, Journal of Lightwave Technology, Vol. 14, No. 7 (1996)). In addition, the known devices based on active components that are able to approach acceptable performance from the point of view of the duration of the emitted optical pulses deliver a relatively low optical power and are very expensive (typically several thousand Euros).

In this context the invention aims to propose a circuit for high-speed drive of an optoelectronic module that is simultaneously of low cost, simple and fast and that enables, in particular, the emission of optical pulses of duration less than 2000 ps and/or a broad frequency-signal modulation exceeding 500 MHz, with a peak power greater than 20 μW, notably of the order of 50 μW for a frequency of 1 GHz.

In order to do this, the invention relates to a circuit for high-speed drive of an optoelectronic device including at least one optoelectronic diode, characterised in that said circuit comprises:
a voltage square wave pulses generator capable of generating voltage square wave pulses having fronts of duration less than 400 ps,
a pulse-shaping circuit for shaping of driving pulses of said optoelectronic device, said pulse-shaping circuit including:
   an output that is suitable to be connected to the optoelectronic device,
   and an input connected to square wave pulses generator and receiving the voltage square wave pulses formed by said generator,
   between a terminal of said input and a terminal of said output connected in series to a power-supply terminal of said optoelectronic device, connected in parallel in relation to one another:
      a first branch formed by a passive rectifier circuit with non-zero threshold voltage, said passive rectifier circuit being in series in the first branch and in the forward direction in relation to said power-supply terminal of the optoelectronic device,
      a second capacitive branch, in particular an exclusively second capacitive branch.

By “passive rectifier circuit” a rectifier circuit is designated that is constituted exclusively by passive electronic components and that, in particular, is free from transistors (such as MOSFET, IGBT etc.). In totally surprising manner it has in fact turned out that such a pulse-shaping circuit, despite its very great simplicity, provides astonishing and unexplained results.

In particular, advantageously and in accordance with the invention said passive rectifier circuit with non-zero threshold voltage (and therefore said first branch) includes at least one diode in series in said first branch—in particular is made up of at least one diode in series in said first branch—and in the forward direction in relation to the power-supply terminal of the optoelectronic device.

More particularly, advantageously and in accordance with the invention said passive rectifier circuit with non-zero threshold voltage exhibits a total threshold voltage greater than 0.5 V and a dynamic resistance less than 50Ω.

In a first embodiment, advantageously and in accordance with the invention said passive rectifier circuit with non-zero threshold voltage (and therefore said first branch) includes at least one Schottky diode. More particularly, said circuit is made up of at least one Schottky diode, in particular a plurality of Schottky diodes in series. The increase in the accumulated total threshold voltage of the Schottky diodes in the first branch enables the charge stored in the second capacitive branch to be increased in the case of operation under bias voltage. Nevertheless, this increase implies a simultaneous increase in the dynamic resistance of the first branch, to the detriment of the value of the drive current.

Advantageously and in accordance with the invention, the first branch is made up of two Schottky diodes in series. This value turns out in fact to constitute a compromise in a large number of situations, notably for driving an optoelectronic device constituted by a commercial LED.

In addition, advantageously and in accordance with the invention each Schottky diode exhibits a threshold voltage of the order of 0.3 V to 0.35 V, a dynamic resistance of the order of 6Ω and a pass-band of the order of 10 GHz.

In another embodiment, advantageously and in accordance with the invention said passive rectifier circuit with non-zero threshold voltage (and therefore said first branch) includes at least one PIN diode. More particularly, said circuit is made up of at least one PIN diode, in particular a single PIN diode, for example a PIN diode exhibiting a threshold voltage of the order of 0.9 V to 1 V, a dynamic resistance of the order of 0.5Ω to 1Ω and a pass-band of the order of 1 GHz to 5 GHz.

In a variant, said passive rectifier circuit with non-zero threshold voltage (and therefore said first branch) may be made up of several components of distinct nature, for example a Schottky diode and a PIN diode in series.

Moreover, advantageously and in accordance with the invention the capacitance of the second branch is between 0.2 times and 2 times the capacitance of the optoelectronic device under zero voltage. The second branch is exclusively capacitive, in the sense that it exhibits values of resistance and of inductance that are negligible in comparison with the value of its capacitance between said input and said output terminal. It is to be noted, moreover, that this series capacitance in the second branch may be formed by all capacitive component(s), in particular by a simple capacitor or by combinations of capacitors.

Advantageously and in accordance with the invention the capacitance of the second branch is between 10 pF and 200 pF. This value is determined, in particular experimentally by tests, in accordance with the optoelectronic device.

Moreover, preferably and notably in the case where the optoelectronic device is constituted by LED(s), the voltage square wave pulses generator is suitable to produce voltage square wave pulses of peak amplitude between 0 V and 4 V of duration between 250 ps and 4 ns.

In addition, advantageously and in accordance with the invention the voltage square wave pulses generator is suitable to provide a DC bias voltage Vc of value less than the total threshold voltage of the first branch, in particular less than the sum of the threshold voltages of the (Schottky and/or PIN) diode(s) of the first branch and of each optoelectronic diode of the optoelectronic device. In an advantageous embodiment according to the invention the voltage square wave pulses generator is suitable to provide a DC bias voltage Vc between 0 V and 3 V.

It is to be noted that the pulse-shaping circuit is connected in series in relation to the optoelectronic device and may therefore be connected either in series with respect to the anode or in series with respect to the cathode of the optoelectronic device. In this way, said output terminal of the pulse-shaping circuit may be a terminal intended to be connected to an anode of the optoelectronic device, whereas the cathode of the optoelectronic device is connected to the negative terminal of the voltage square wave pulses generator. In a variant, said output terminal of the pulse-shaping circuit may be, on the contrary, a terminal intended to be connected to a cathode of the optoelectronic device, whereas the anode of the optoelectronic device is connected to the positive terminal of the voltage square wave pulses generator. In all cases, said rectifier circuit with non-zero threshold voltage, and in particular each Schottky diode or PIN diode, is connected in the forward direction in relation to the power-supply terminal of the optoelectronic device to which the pulse-shaping circuit is connected.

Moreover, advantageously and in accordance with the invention the voltage square wave pulses generator includes a device for shaping of voltage square wave pulses, having a switching diode with electrostatic memory (step-recovery diode). It has in fact turned out that such a device having a switching diode with electrostatic memory provides a particularly astonishing result in combination with the pulse-shaping circuit in conformity with the invention.

The voltage square wave pulses generator preferably includes a periodic-signal generator energizing said device for shaping of voltage square wave pulses.

The invention also relates to a circuit characterised in combination by all or some of the characteristics mentioned above or below.

Other objectives, features and advantages of the invention will become apparent upon reading the following description of various embodiments of the invention, which are given solely by way of non-limiting examples, which refers to the appended Figures in which:

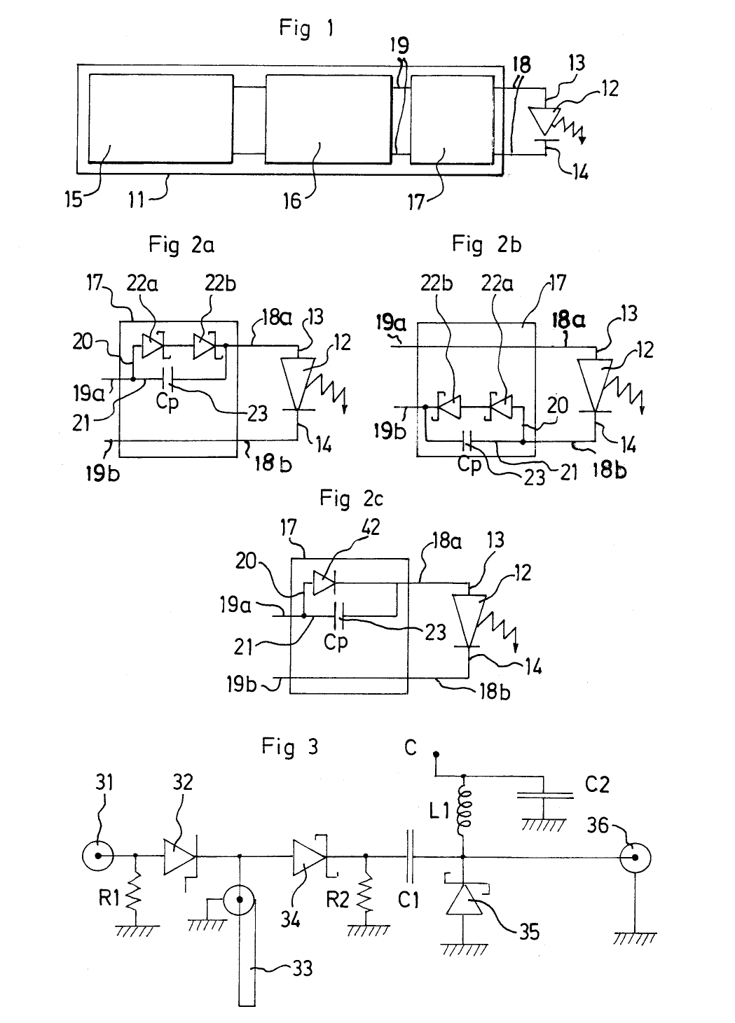

FIG. 1 is a block diagram illustrating a drive circuit according to the invention connected to an LED,

FIGS. 2a, 2b and 2c are electronic diagrams of three embodiments of the pulse-shaping circuit of a drive circuit according to the invention,

FIG. 3 is an electronic diagram of an embodiment of the circuit for shaping of voltage square wave pulses of a drive circuit according to the invention,

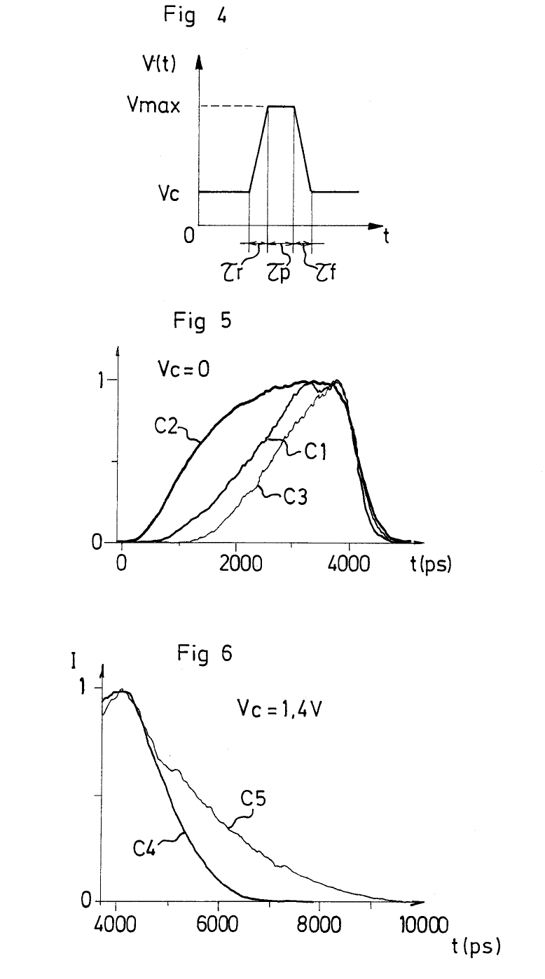

FIG. 4 is a diagram illustrating the character of the voltage square wave pulses provided at the output of the module for shaping of voltage square wave pulses shown in FIG. 3,

FIG. 5 is a diagram illustrating curves of appearance of the normalised intensity of electro-luminescence of an LED without bias voltage and according to the drive circuit being used,

FIG. 6 is a diagram illustrating curves of decay of the normalised intensity of the electroluminescence of an LED under bias voltage and according to the drive circuit being used,

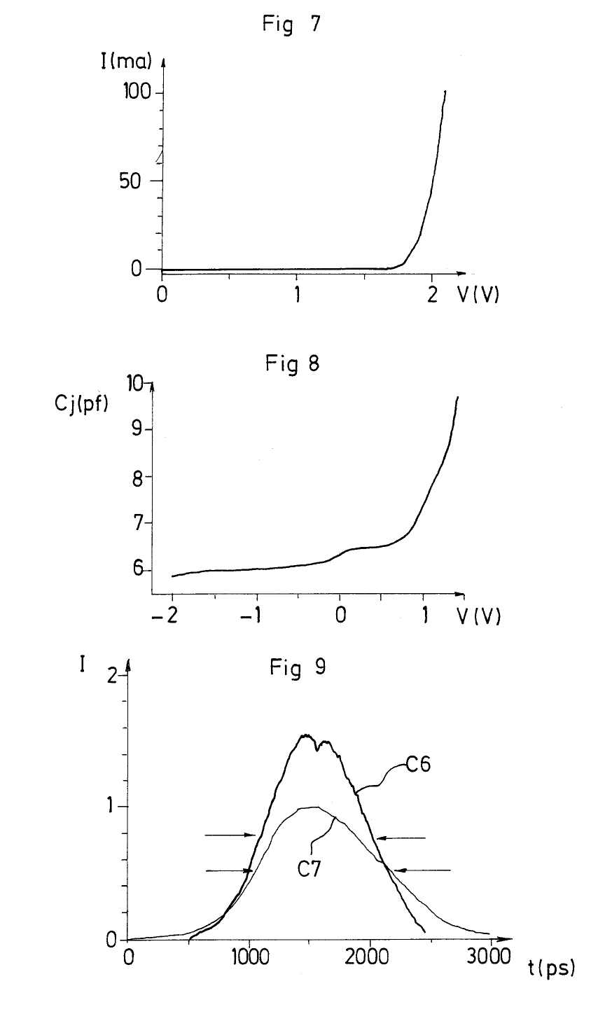

FIG. 7 is a diagram illustrating a characteristic intensity/voltage curve of a first LED emitting in the visible range,

FIG. 8 is a diagram illustrating a characteristic junction-capacitance/voltage curve of the first LED,

FIG. 9 is a diagram illustrating progression curves of the normalised intensity of the electroluminescence of the first LED in pulsed mode according to the drive circuit being used,

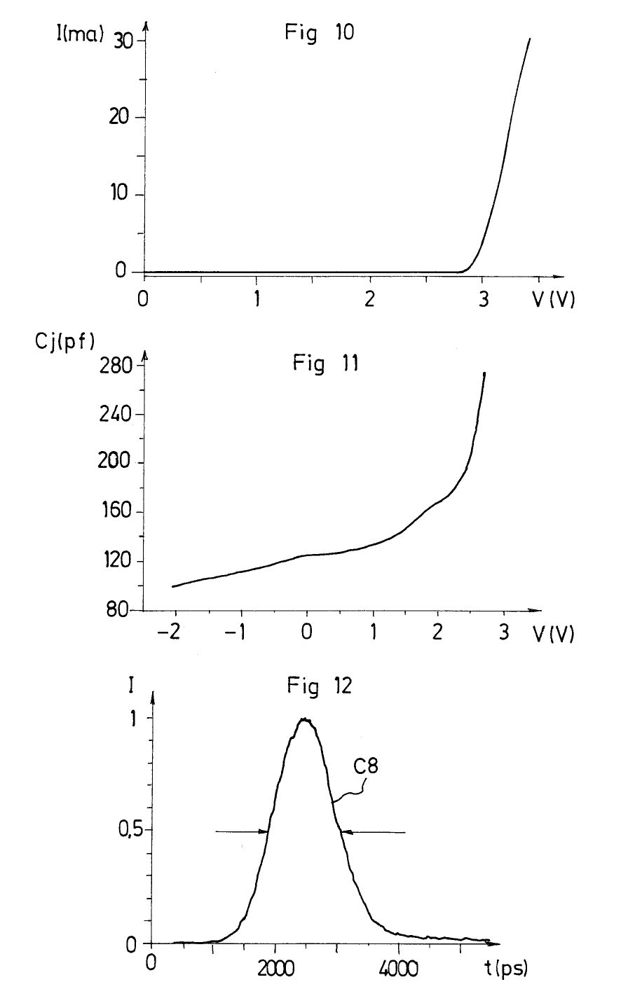

FIG. 10 is a diagram illustrating a characteristic intensity/voltage curve of a second LED emitting in the ultraviolet range,

FIG. 11 is a diagram illustrating a characteristic junction-capacitance/voltage curve of the second LED,

FIG. 12 is a diagram illustrating the progression curve of the normalised intensity of the electroluminescence of the second LED in pulsed mode,

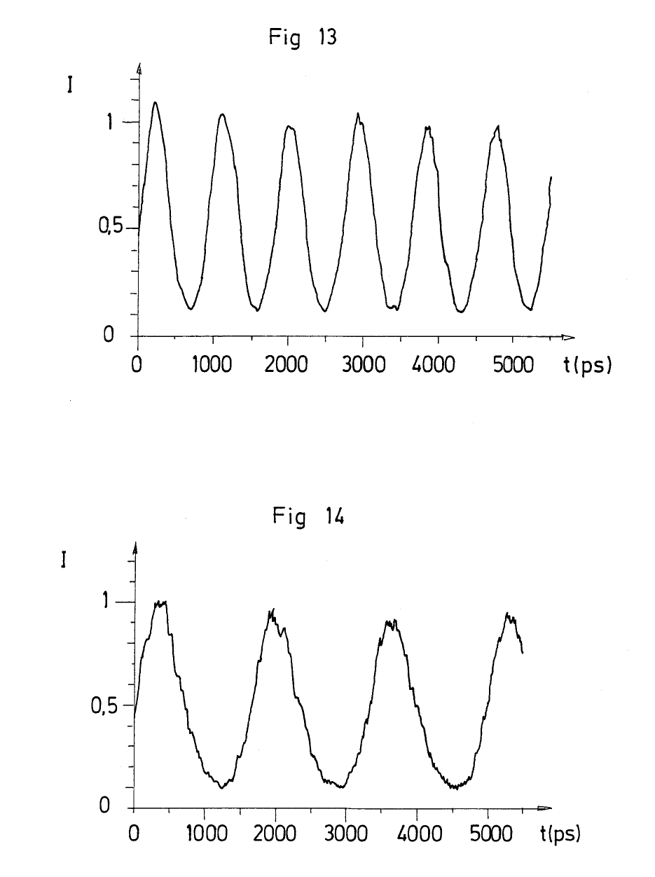

FIG. 13 is a diagram illustrating the variations in the electroluminescence in the course of time of the first LED driven at high frequency with a circuit according to the invention,

FIG. 14 is a diagram similar to FIG. 13 for a third LED emitting at 850 nm,

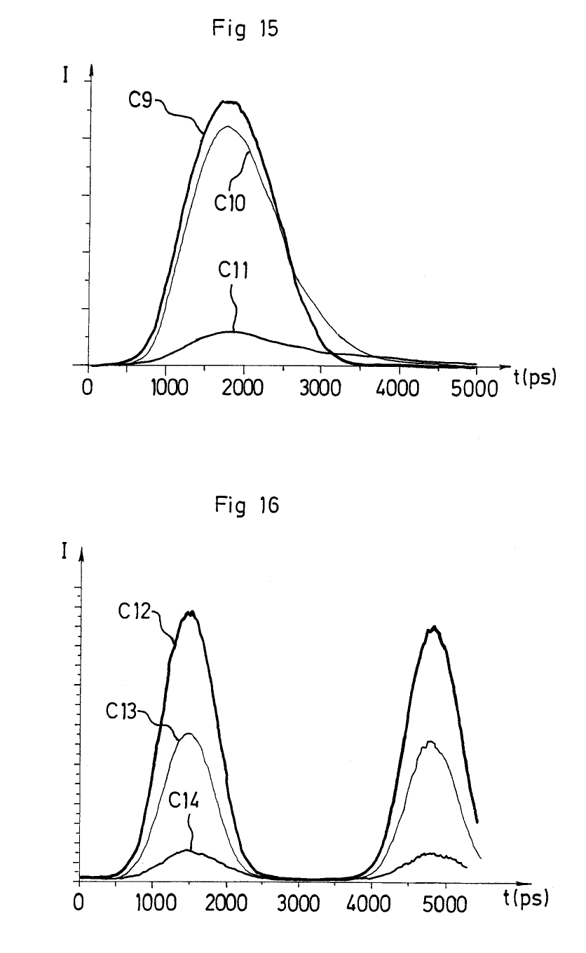

FIG. 15 is a diagram illustrating progression curves of the normalised intensity of the electroluminescence of a fourth LED at 40 MHz according to the drive circuit being used,

FIG. 16 is a diagram illustrating progression curves of the normalised intensity of the electroluminescence of the fourth LED at 300 MHz according to the drive circuit being used.

In the example illustrated in FIG. 1 a drive circuit 11 according to the invention is connected to the terminals (anode 13 and cathode 14) of an LED 12. This drive circuit 11 comprises, successively, a periodic-signal generator 15, a circuit 16 for shaping of voltage square wave pulses starting from the signal provided by the generator 15, and a circuit 17 for shaping of driving pulses of the LED 12 starting from the voltage square wave pulses provided by the circuit 16 for shaping of voltage square wave pulses.

Embodiments of the pulse-shaping circuit 17 are represented in more detail in FIGS. 2a to 2c.

This circuit 17 includes an output 18 comprising a terminal 18a, connected to the anode 13 of the LED 12, and a terminal 18b, connected to the cathode 14 of the LED 12. The circuit 17 also includes an input 19 comprising two terminals 19a, 19b connected to the corresponding output terminals of said voltage square wave pulses generator 15.

Between an input terminal 19a or 19b and the corresponding output terminal 18a or 18b (i.e., of the same polarity) the circuit 17 includes two branches 20, 21 connected in parallel in relation to one another. The other input terminal 19b or 19a is directly connected to the corresponding other output terminal 18b or 18a.

The first branch 20 is made up of a passive rectifier circuit with non-zero threshold voltage, in particular constituted by at least one diode 22a, 22b, 42 connected in series in this branch 20 and in the forward direction in relation to the LED 12.

In the first embodiment shown in FIG. 2a the two branches 20, 21, and therefore the output terminal 18a of positive polarity, are connected to the anode 13 of the LED 12, this anode 13 acting as power-supply terminal of the LED 12. The cathode 14 of the LED 12 is directly connected to the other output terminal 18b of negative polarity, and therefore also to the input terminal 19b of negative polarity. The first branch 20 is constituted by at least one Schottky diode 22a, 22b connected in series in the first branch 20 and in the forward direction in relation to the LED 12.

In the second embodiment represented in FIG. 2b the two branches 20, 21 as well as the output terminal 18b of negative polarity are connected to the cathode 14 of the LED 12, this cathode 14 acting as power-supply terminal of the LED 12. The anode 13 of the LED 12 is directly connected to the other output terminal 18a of positive polarity, and therefore also to the input terminal 19a of positive polarity.

The third embodiment represented in FIG. 2c is similar to the first embodiment shown in FIG. 2a and differs therefrom only by virtue of the fact that the first branch 20 is made up of a PIN (positive intrinsic negative) diode 42 connected in series in the first branch 20 and in the forward direction in relation to the LED 12.

Whatever the case, each Schottky diode 22a, 22b or PIN diode 42 is connected in the forward direction, i.e., in the same direction as the LED 12.

Each Schottky diode 22a, 22b typically exhibits a threshold voltage of the order of 0.3 V to 0.35 V, a dynamic resistance of the order of 6Ω and a pass-band of the order of 10 GHz. The number of Schottky diodes 22a, 22b in the first branch 20 is preferably suitable so that this first branch 20 exhibits a total threshold voltage greater than 0.5 V, in particular of the order of 0.6 V to 0.7 V, and a dynamic resistance less than 50Ω, in particular of the order of 20Ω. Each PIN diode 42 exhibits a threshold voltage of the order of 0.9 V to 1 V, a dynamic resistance of the order of 0.5Ω to 1Ω and a pass-band of the order of 1 GHz to 5 GHz.

In the first two preferred embodiments represented in FIGS. 2a and 2b the first branch 20 includes two identical Schottky diodes 22a, 22b in series. In the third preferred embodiment represented in FIG. 2c the first branch 20 includes a single PIN diode 42, for example a Philips® silicon diode, reference BAP 1321-04, exhibiting a threshold voltage of 0.95 V, a pass-band 3 GHz and a dynamic resistance of 0.85Ω.

The second branch 21 is a capacitive branch, i.e., it exhibits a capacitance of predetermined value Cp between the input terminal 19a or 19b and the output terminal 18a or 18b, in parallel with the Schottky diodes 22a, 22b. It is preferable that the second branch 21 is exclusively capacitive, i.e., the resistive and inductive components of its impedance are negligible between the input terminal 19a or 19b and the output terminal 18a or 18b. The value of the capacitance Cp of the second capacitive branch 21 may be obtained in any suitable manner. The simplest is to make provision that the second branch 21 is formed by a capacitor 23 connected between the input terminal 19a or 19b and the output terminal 18a or 18b.

The number of Schottky diodes of the first branch 20 may be different from two. This number is determined in such a way as to find the best compromise between:
the charge Q stored in the second capacitive branch 21, the maximum value of which under bias voltage is:

Q=n·Vs·Cp

n being the number of Schottky diodes,
Vs being the threshold voltage of each Schottky diode, typically of the order of 0.3 V to 0.35 V,
the value of the maximum intensity of the current of the driving pulses provided: this intensity is the greater, the lower the sum of the dynamic resistances of Schottky diodes 22a, 22b, that is to say, the smaller n is. The greater the value of the maximum intensity of the pulses, the greater the optical power emitted by the LED 12.

Moreover, the value of the capacitance Cp of the second capacitive branch 21 is between 10 pF and 200 pF and is optimised in order to be adapted to the junction capacitance Cj exhibited by the driven optoelectronic device (LED 12).

If Cj₀ is the junction capacitance under zero voltage of the LED 12, a capacitance Cp between 0.2.Cj₀ and 2.Cj₀ can be chosen, that is, between 5 pF and 50 pF for commercial LEDs, in particular of the order of 10 pF to 20 pF. This being the case, this optimisation has to be implemented by successive tests, in view of the fact that the junction capacitance Cj depends on the voltage applied to the terminals of the LED 12, which does not exhibit linear electrical behaviour.

In a circuit according to the invention the circuit for shaping of driving pulses has to be energized by voltage square wave pulses exhibiting rising and falling edges of very short duration τᵣ, τ_{f}, shorter than 400 ps, typically between 50 ps and 400 ps, for example of the order of 100 ps to 350 ps. The duration τₚ of each voltage square wave pulse in its portion where the voltage is constant is greater than the duration of each edge of the square wave pulse and is between 250 ps and 4 ns.

The maximum voltage amplitude Vmax of each voltage square wave pulse is between 0 V and 4 V, for example of the order of 2 V, and is preferably adjustable.

The periodic-signal generator 15 and circuit 16 for shaping of voltage square wave pulses constitute a voltage square wave pulses generator 15,16 as mentioned above.

The periodic-signal generator 15 is, for example, a commercial sinusoidal-signal generator providing a signal, the frequency of which determines that of the voltage square wave pulses and therefore that of the driving pulses that have to be applied to the optoelectronic device 12. For example, the periodic-signal generator 15 is chosen in order to be able to provide a signal of frequency between 1 Hz and 2 GHz, in particular between 1 Hz and 80 MHz for applications of the invention in scientific instrumentation and between 600 MHz and 1 GHz for applications of the invention in the field of optical telecommunications, and of amplitude between 0 V and 10 V, in particular of the order of 5 V.

FIG. 3 represents a diagram of an embodiment of the circuit 16 for shaping of voltage square wave pulses. This circuit includes, successively, an SMA coaxial input 31 receiving the periodic signal provided by the generator 15, a parallel resistor R1, a switching diode 32 with electrostatic memory (so-called SRD diode) connected in series and in the forward direction, a variable-delay line capable of being made up of a semi-rigid cable, the length of which can be adjusted, a Schottky diode 34 connected in series and in the forward direction, a parallel resistor R2, a series capacitor of capacitance C1, a Schottky diode 35 connected in parallel and in the reverse direction, a parallel inductance coil L1 energized by a source of DC bias voltage Vc via a parallel smoothing capacitor of capacitance C2, and an SMA coaxial output 36.

For example, the circuit 16 can be implemented with the following values: R1=56Ω, R2=100Ω, C1=470 nF, L1=33 pH, C2=100 nF.

FIG. 4 illustrates the appearance of a voltage square wave pulse delivered to the output 36 of the circuit 16.

If the invention is intended to drive a source of pulsed light that is used in a scientific-instrumentation chain (time-resolved fluorescence, optical detection of molecules, protein fluorescence, etc.), this light-source has to be driven in pulsed operation at low repetition frequency. It is then advisable to find a compromise between the shortest possible width of each optical pulse and the highest possible optical power.

If the invention is intended to drive a source of pulsed light that is used for telecommunications over short distances, this light-source has to be driven in pulsed operation at very high repetition frequency. It is then advisable to find a compromise between the highest possible repetition frequency and the highest possible optical power.

In practice, depending on the application of the invention, the value of the bias voltage Vc superposed on the voltage square wave pulse produced by the circuit 16 is adjusted in order to find the best compromise.

The performance of the voltage square wave pulses generator 15,16 depends, in particular, on the voltage delivered by the periodic-signal generator 15 and on the characteristics of the switching diode 32 with electrostatic memory of the circuit 16 for shaping of voltage square wave pulses. In the examples mentioned below, two different set-ups A and B were used.

Set-up A: Use is made of a switching diode 32 with electrostatic memory, the rise-time of which is 35 ps (for example, the SRD diode, reference MMDB830-E28, marketed by Aeroflex Metelics company (NH 03053, USA, http://www.aeroflex.com/ams/metelics). The circuit 16 is energized by a sinusoidal-signal generator 15 with an effective amplitude varying from 0 mV to 90 mV. An amplifier, for example of type Minicircuit ZHL-42W (http://www.mini-circuit.com; not represented), enables the amplitude (gain 30 dB) to be amplified if necessary. The rise-time (and fall-time) of each square wave pulse produced by the circuit 16 is between 100 ps and 200 ps, and the duration of the square wave pulse is from 250 ps to 2 ns (according to the length of the delay line 33). The maximum peak-to-peak output voltage Vmax is of the order of 3 V, and the repetition frequency is of the order of 600 MHz to 1.1 GHz. This set-up A can be used for applications of the invention in scientific-instrumentation chains at low frequencies and for applications of the invention in telecommunications at high frequencies.

Set-up B: Use is made of a switching diode 32 with electrostatic memory, the rise-time of which is 70 ps (for example, an SRD diode, reference SMMD835-E28 marketed by Aeroflex Metelics company (NH 03053, USA, http://www.aeroflex.com/ams/metelics). The circuit 16 is energized by a square wave pulses signal generator 15 exhibiting times of rise and fall of each square wave pulse of the order of 3 ns (time measured when the signal goes from 10% to 90% of its final value), a low level varying between −0.6 V and −7 V, and a high level of 3 V, and a square wave pulse duration of the order of 20 ns. The rise-time (and fall-time) of each square wave pulse produced by the circuit 16 for shaping of the voltage square wave pulses is of the order of 200 ps to 300 ps, and the duration of the square wave pulse is from 0.5 ns to 4 ns, according to the length of the delay line 33. The maximum peak-to-peak output voltage Vmax is of the order of 4 V, and the maximum repetition frequency is of the order of 200 MHz. This set-up B can be used for applications of the invention in scientific-instrumentation chains, as well as for characterising the rise-times and decay-times of the electroluminescence of commercial LEDs at low repetition frequency (less than or equal to 100 MHz).

In the tests implemented, the electroluminescence of an LED 12 energized by a drive circuit according to the invention is measured with the aid of an high-speed detector. This detector is made up of a camera using slit scanning, marketed under reference ‘Streakscope C4334’ by Hamamatsu (http://www.hamamatsu.com) and equipped with a photocathode marketed by the same company under reference S20 (C4334-02). The temporal resolution depends on the chosen scanning scale: 25 ps for a scanning scale of 1 ns, 125 ps for 5 ns. The detector is synchronised with respect to the electrical pulse sent to the LED. The electroluminescence of the LED is collected by a first lens and is focused by a second lens into a spectrometer (focal length: 25 cm, grating 600 lines/mm, dispersion of 5 nm/mm). The light is then focused onto the input slit of the detector. The measured signal is therefore the intensity of luminescence as a function of time and of wavelength. By integrating numerically over the entire spectral width of the emission, the intensity of luminescence is finally obtained as a function of time. The current is measured by a load resistor of 1Ω in series with the LED 12 and by an oscilloscope branched in parallel to the terminals of this resistor, the pass-band of the set-up for detection of the current being of the order of 2 GHz.

### EXAMPLE 1

### Operation without Bias

In this example, use is made of set-up B in order to drive an LED 12 emitting at a wavelength of 650 nm, marketed under reference L9907 by Hamamatsu company (http://www.hamamatsu.com). The characteristics of this LED are represented in FIGS. 7 and 8. Its threshold voltage is 1.7 V. Its capacitance Cj₀ under zero voltage is 6 pF.

The circuit 17 for shaping of driving pulses is in conformity with FIG. 2a and includes two Schottky diodes. The following are chosen: Vc=0 V, τᵣ=τ_{f}=350 ps, τ_{P}=4 ns, Vmax=1.5 V.

Curve C1 of FIG. 5 is obtained with a circuit according to the invention for Cp=100 pF. Curve C2 of FIG. 5 is obtained with a circuit according to the invention for Cp=22 pF.

By way of comparative test, curve C3 of FIG. 5 is obtained with a circuit not in conformity with the invention, in which the circuit 17 for shaping of driving pulses according to the invention is replaced by a series resistor of 33Ω.

The initial moment of appearance of electroluminescence and the rise-time of the electroluminescence are controlled by the charging of the capacitor Cj of the LED 12. As can be seen, the invention enables the duration of appearance of electroluminescence, on the one hand, and the duration of the rise of electroluminescence, on the other hand, to be reduced.

When the bias voltage Vc is zero, the decay-time of the electroluminescence is in all cases essentially dependent on the scanning of the charge-carriers outside the active zone when the capacitor Cj discharges.

### EXAMPLE 2

### Decay-Time with Non-Zero Bias Voltage

When the LED 12 is energized with a non-zero bias voltage Vc the system breaks free from the phases of charging and discharging the capacitor Cj. The amplitude of the voltage of the driving pulses can therefore be smaller, the threshold voltage of the LED being already attained with the aid of this bias voltage. This operating mode is of interest, in particular, in high-frequency applications.

Nevertheless, the decay-time of the electroluminescence of the LED is then essentially dependent on the lifetime of the charge-carriers and no longer on the scanning-time of the charge-carriers outside the active zone. The result of this is that the decay-time of the electroluminescence is longer.

The invention nevertheless enables the decay-time of the electroluminescence under bias to be reduced, as the example illustrated in FIG. 6 shows.

In this example, use is made of the same LED as in Example 1. The circuit 17 for shaping of driving pulses includes a Schottky diode. The following are chosen: Vc=1.4 V, τᵣ=τ_{f}=350 ps, τₚ=4 ns, Vmax=0.6 V. Curve C4 of FIG. 6 is obtained with a circuit according to the invention for Cp=100 pF.

By way of comparative test, curve C5 of FIG. 6 is obtained with a circuit in which the circuit 17 for shaping of driving pulses according to the invention is replaced by a series resistor of 33Ω.

As can be seen, the decay-time, measured between 90% and 10% of the maximum value of the electroluminescence, is of the order of 1.6 ns with a drive circuit according to the invention, whereas it is 3.5 ns in the comparative test.

In general manner, the best results were obtained by using a bias voltage Vc less than the sum of the threshold voltages of the LED 12 and of the Schottky diode(s).

### EXAMPLE 3

### Operation at Low Repetition Frequency

In this example, use is made of the same LED as in Example 1.

Tests are implemented with a drive circuit in conformity with the invention, in which the generator 15, 16 is in conformity with set-up A. The circuit 17 for shaping of driving pulses is in conformity with FIG. 2a and includes two Schottky diodes. The following are chosen: Vc=1.92 V, τᵣ=τ_{f}=200 ps, τₚ=0.5 ns, Vmax=0.9 V. The pulse repetition frequency is 80 MHz. The drive intensity of the LED is 100 mA. The peak-to-peak power is 206 μW.

Curve C6 of FIG. 9 represents the normalised intensity of electroluminescence emitted by the LED and is obtained with a circuit according to the invention for Cp=10 pF.

By way of comparative test, curve C7 of FIG. 9 is obtained with a circuit in which the Schottky diodes of the circuit 17 for shaping of driving pulses according to the invention are replaced by a series resistance of 30Ω with Vc=1.5 V, Vmax=0.75 V, and a drive intensity of 100 mA and a peak-to-peak power of 105 μW. Curve C7 therefore represents the results obtained with a known parallel R-C pulse-shaping circuit, not in conformity with the invention.

Table 1 below illustrates the various results obtained in this example.

TABLE 1

| | | Parallel R-C circuit | | | | | |
|---|---|---|---|---|---|---|---|
| | | (comparative test) | | | Circuit of the invention | | |
| | | Mean power | Peak- | Light | Mean power | Peak- | Light |
| | | at | to-peak | pulse | at | to-peak | pulse |
| τₚ | | 80 MHz | power | (FWHM) | 80 MHz | power | (FWHM) |
| 500 | ps | 9.7 μW | 0.10 mW | 1150 ps | 15 μW | 0.20 mW | 920 ps |
| 1 | ns | 25 μW | 0.25 mW | 1200 ps | 36 μW | 0.40 mW | 1200 ps |
| 2 | ns | 61 μW | 0.40 mW | 1860 ps | 80 μW | 0.5 mW | 1760 ps |

The comparison between the drive circuit according to the invention, with Schottky diodes and parallel capacitance, and the drive circuit based on a parallel R-C circuit shows that, for the same current, the drive circuit according to the invention leads to:
a higher optical power (up to a factor of 2) with the aid of a more substantial initial intensity-peak effect,
a shorter light-pulse duration (up to 20%).

No clear explanation can be given for these unexpected results.

Moreover, the performance data obtained with the drive circuit according to the invention are similar to those obtained with drive circuits pertaining to the prior state of the art and based on active components which are much more costly and temperature-sensitive.

The invention can therefore be applied, in particular, in order to drive an optoelectronic device in scientific instrumentation so as to produce very short pulses at a relatively low frequency.

### EXAMPLE 4

### UV LED

This example is similar to Example 3, but was carried out with an LED 12 emitting in the ultraviolet range, namely an LED marketed under reference HUV400-5X0B by Hero-Led company (http://www.hero-led.com). The characteristics of this LED are represented in FIGS. 10 and 11. Its threshold voltage is 2.75 V. Its capacitance under zero voltage Cj₀ is 125 pF. Its central emission wavelength is 400 nm with a spectral width of 20 nm.

Set-up A is chosen, and Vc=2.7 V, τᵣ=τ_{f}=200 ps, τₚ=0.5 ns, Vmax=3 V. The pulse repetition frequency is 80 MHz. The drive intensity of the LED is 300 mA. The peak-to-peak power is 1800 μW. The circuit 17 for shaping of driving pulses includes two Schottky diodes, and Cp=22 pF.

FIG. 12 represents curve C8 illustrating the normalised intensity of the electroluminescence emitted by the LED in pulsed mode.

Table 2 below illustrates the various results obtained in this example.

TABLE 2

| | Circuit of the invention | | |
|---|---|---|---|
| | Mean power | Peak-to-peak | Light pulse |
| τₚ | at 40 MHz | power | (FWHM) |
| 500 ps | 80 μW | 1.8 mW | 1100 ps |
| 1 ns | 163 μW | 3.3 mW | 1250 ps |
| 2 ns | 310 μW | 5.5 mW | 1400 ps |

### EXAMPLE 5

### High-Frequency Operation

In this example it is shown that a drive circuit in conformity with the invention enables a broad signal modulation from 500 MHz to 1 GHz to be obtained with a peak-to-peak power from 20 μW to 100 μW.

Tests are implemented with an LED 12 identical to that of Example 1, with a drive circuit in conformity with the invention, in which the generator 15, 16 is in conformity with set-up A. The circuit 17 for shaping of driving pulses is in conformity with FIG. 2a and includes two Schottky diodes. The following are chosen: Vc=0.6 V, τᵣ=τ_{f}=200 ps, τₚ=0.5 ns, Vmax=2.5 V, Cp=10 pF. The pulse repetition frequency is 1 GHz. The drive intensity of the LED is 75 mA. The peak-to-peak power is 45 μW.

FIG. 13 illustrates the progression of the normalised intensity of electroluminescence as a function of time.

Table 3 below illustrates the various results obtained with this LED, including those of a comparative test carried out with a parallel R-C drive circuit as in Example 3.

TABLE 3

| | | Parallel R-C | |
|---|---|---|---|
| | | circuit | |
| | | (comparative | Circuit of |
| | | test) | the invention |
| | | Peak-to-peak | Peak-to-peak |
| Frequency | Intensity | power | power |
| 500 MHz | 100 mA | 40 μW | 95 μW |
| 600 MHz | 100 mA | 24 μW | 85 μW |
| 1 GHz | 75 mA | 10 μW | 45 μW |

### EXAMPLE 6

### LED at 850 nm

This example is similar to Example 5, but use is made of a different LED 12, namely an LED marketed under reference OP245PS by Optek company (http://www.optekinc.com) and emitting at a wavelength of 850 nm, exhibiting a threshold voltage of 1.5 V and a capacitance under zero voltage Cj₀ of 50 pF. Such a wavelength presents interest, in particular, for communications by optical fibre.

The test is implemented with a drive circuit in conformity with the invention, in which the generator 15, 16 is in conformity with set-up A. The circuit 17 for shaping of driving pulses is in conformity with FIG. 2a and includes two Schottky diodes. The following are chosen: Vc=0 V, τᵣ=τ_{f}=200 ps, τₚ=0.5 ns, Vmax=3 V, Cp=10 pF. The pulse repetition frequency is 600 MHz. The drive intensity of the LED is 100 mA. The peak-to-peak power is 20 μW. The mean power is 8 μW.

FIG. 14 illustrates the progression of the normalised intensity of electroluminescence as a function of time.

### EXAMPLE 7

This example is similar to Example 3 but was carried out with an LED marketed under reference RCXR65-RSPOU by Roithner company (http://www.roithner-laser.com) and with three distinct circuits for shaping of command pulses: a first circuit 17 in conformity with FIG. 2a, the passive rectifier circuit with non-zero threshold voltage which includes two Schottky diodes; a second circuit 17 in conformity with FIG. 2c, the passive rectifier circuit with non-zero threshold voltage which includes a PIN diode; and, by way of comparison, a third circuit not in conformity with the invention, in which the LED is driven without driver (a resistor of 28Ω is, however, placed in series with the LED in order to implement the tuning of impedance).

The PIN diode exhibits a threshold voltage of 0.95 V, a pass-band of 3 GHz and a dynamic resistance of 0.85Ω.

The LED exhibits a threshold voltage of 1.75 V and a junction capacitance under zero voltage Cj₀ of 13.5 pF. Its central emission wavelength is 650 nm.

The following are chosen: Vc=1.5 V, τᵣ=τ_{f}=100 ps, τₚ=1 ns, Vmax=5 V, Cp=22 pF. The circuit 16 is energized by a sinusoidal-signal generator 15 with an amplitude capable of reaching 150 mV, and the pulse repetition frequency in this example is 40 MHz.

Curve C9 of FIG. 15 represents the normalised intensity of electroluminescence emitted by the LED and is obtained with the first circuit according to the invention with Schottky diodes. Curve C10 of FIG. 15 represents the normalised intensity of electroluminescence emitted by the LED and is obtained with the second circuit according to the invention with PIN diode.

By way of comparative test, curve C11 of FIG. 15 is obtained with the third circuit, not in conformity with the invention.

As can be seen, the results obtained with the two circuits in conformity with the invention are similar (light-pulse duration of the order of 1.36 ns) and very clearly different from and superior to those obtained with the circuit not in conformity with the invention.

### EXAMPLE 8

This example is similar to Example 7 and is distinguished therefrom only by the repetition frequency which is 300 MHz (and not 40 MHz as in Example 7).

Curve C12 of FIG. 16 represents the normalised intensity of electroluminescence emitted by the LED and is obtained with the first circuit according to the invention with Schottky diodes. Curve C13 of FIG. 16 represents the normalised intensity of electroluminescence emitted by the LED and is obtained with the second circuit according to the invention with PIN diode.

By way of comparative test, curve C13 of FIG. 16 is obtained with the third circuit, not in conformity with the invention.

Here again it will be noticed that the results obtained with the two circuits in conformity with the invention are clearly superior to those obtained with the circuit not in conformity with the invention. In addition, the results obtained with the first circuit in conformity with the invention, the passive rectifier circuit with non-zero threshold voltage of which is composed of two Schottky diodes in series, are superior to those obtained with the second circuit in conformity with the invention, the passive rectifier circuit with non-zero threshold voltage of which is composed of a PIN diode. The duration of the light pulse is 0.875 ns with the first circuit in conformity with the invention, 0.839 ns with the second circuit in conformity with the invention, and 0.966 ns with the third circuit not in conformity with the invention.

It goes without saying that the invention may be the object of very numerous practical variants in comparison with the embodiments and examples described above. In particular, it can be applied just as well to the drive of laser diodes or of other more complex optoelectronic devices.

1-15. (canceled)

16. Circuit for high-speed drive of an optoelectronic device including at least one optoelectronic diode (12), wherein said circuit comprises:
a voltage square wave pulses generator (15, 16) exhibiting edges of duration shorter than 400 ps,
a pulse-shaping circuit (17) for shaping of driving pulses of the optoelectronic device, said pulse-shaping circuit (17) including:
an output (18) that is suitable to be connected to the optoelectronic device,
and an input (19) connected to the voltage square wave pulses generator (15, 16) and receiving the voltage square wave pulses formed by said generator,
between a terminal (19a or 19b) of said input and a terminal (18a or 18b) of said output connected in series to a terminal (13 or 14) for energizing said optoelectronic device, connected in parallel in relation to one another:
a first branch (20) made up of a passive rectifier circuit (22a, 22b) with non-zero threshold voltage, said passive rectifier circuit being in series in the first branch and in the forward direction in relation to said terminal (13 or 14) for energizing the optoelectronic device,
a second capacitive branch (21).

17. Circuit as claimed in claim 16, wherein said passive rectifier circuit (22a, 22b) with non-zero threshold voltage is made up of at least one diode in series in the first branch and in the forward direction in relation to said terminal (13 or 14) for energizing the optoelectronic device.

18. Circuit as claimed in claim 16, wherein said passive rectifier circuit (22a, 22b) with non-zero threshold voltage exhibits a total threshold voltage greater than 0.5 V and a dynamic resistance less than 50Ω.

19. Circuit as claimed in claim 16, wherein said passive rectifier circuit (22a, 22b) with non-zero threshold voltage includes at least one Schottky diode (22a, 22b).

20. Circuit as claimed in claim 16, wherein said passive rectifier circuit (22a, 22b) with non-zero threshold voltage is made up of a plurality of Schottky diodes (22a, 22b) in series.

21. Circuit as claimed in claim 20, wherein said passive rectifier circuit (22a, 22b) with non-zero threshold voltage is made up of two Schottky diodes in series, and in that each Schottky diode (22a, 22b) exhibits a threshold voltage of the order of 0.3 V to 0.35 V, a dynamic resistance of the order of 6Ω and a pass-band of the order of 10 GHz.

22. Circuit as claimed in claim 16, wherein said passive rectifier circuit (22a, 22b) with non-zero threshold voltage includes at least one PIN diode.

23. Circuit as claimed in claim 16, wherein said passive rectifier circuit (22a, 22b) with non-zero threshold voltage is made up of a PIN diode exhibiting a threshold voltage of the order of 0.9 V to 1 V, a dynamic resistance of the order of 0.5Ω to 1Ω and a pass-band of the order of 1 GHz to 5 GHz.

24. Circuit as claimed in claim 16, wherein the capacitance of the second branch (21) is between 0.2 times and 2 times the capacitance of the optoelectronic device under zero voltage.

25. Circuit as claimed in claim 16, wherein the capacitance of the second branch (21) is between 10 pF and 200 pF.

26. Circuit as claimed in claim 16, wherein the voltage square wave pulses generator (15, 16) is suitable to produce voltage square wave pulses of peak amplitude between 0 V and 4 V of duration between 250 ps and 4 ns.

27. Circuit as claimed in claim 16, wherein the voltage square wave pulses generator (15, 16) is suitable to provide a DC bias voltage Vc of value less than the total threshold voltage of the first branch (20) and of each optoelectronic diode (12) of the optoelectronic device.

28. Circuit as claimed in claim 16, wherein the voltage square wave pulses generator (15, 16) is suitable to provide a DC bias voltage Vc between 0 V and 3 V.

29. Circuit as claimed in claim 16, wherein the voltage square wave pulses generator (15, 16) includes a device (16) for shaping of voltage square wave pulses with a switching diode (32) with electrostatic memory.

30. Circuit as claimed in claim 29, wherein the voltage square wave pulses generator (15, 16) includes a periodic-signal generator (15) energizing said device (16) for shaping of voltage square wave pulses.
